(19) United States
(12) Patent Application Publication
(10) Pub. No.: US 2004/0156092 A1
(43) Pub. Date: Aug. 12, 2004

(54) Stimulated Rayleigh scattering optical amplifier

(76) Inventors: Jeffrey H. Hunt, Chatsworth, CA (US); Robert J. Atmur, Whittier, CA (US)

Correspondence Address: WILLIAM C. ANDERSON, THE BOEING COMPANY, MC 1650-7009, 15460 LAGUNA CANYON ROAD, IRVINE, CA, 92618, US

(21) Appl. No.: 10/361,060

(22) Filed: Feb. 8, 2003

(51) Int. Cl. H01S 3/00

(52) U.S. Cl. 359/333

(57) ABSTRACT

The stimulated Rayleigh scattering optical amplifier includes a first control optics assembly, a driver element, a second control optics assembly, a Rayleigh active medium, and egressing optics. The first control optics assembly receives an incoming laser beam and adjusts that incoming laser beam in accordance with first desired wavelength, polarization and beam propagation parameters. A driver element produces a driver laser beam. A second control optics assembly receives the driver laser beam and adjusts that driver laser beam in accordance with second desired wavelength, polarization and beam propagation parameters. A Rayleigh active medium receives an output from the first control optics assembly and an output from the second control optics assembly. The Rayleigh active medium provides a non-linear optical interaction between the outputs such that the incoming laser beam is amplified producing an amplified Rayleigh active medium output laser beam and a depleted driver laser beam. Egressing optics receives the amplified Rayleigh active medium output laser beam and the depleted driver laser beam. The egressing optics controllably transmits the amplified Rayleigh active medium output laser beam in accordance with third desired wavelength, polarization, and beam propagation parameters and prevents transmission of the depleted driver laser beam. The output of the egressing optics includes an amplified egressing optics output laser beam.

### BACKGROUND OF THE INVENTION

1. Field of the Invention

This invention relates to optical amplifiers and more particularly to an optical amplifier that uses stimulated Rayleigh scattering for providing optical amplification.

2. Description of the Related Art

Heretofore, the field of optical signal amplifiers has been dominated by Raman amplifiers. For example, U.S. Pat. No. 3,414,354, issued to E. H. Siegler Jr., entitled Raman Spectrometers, is a seminal publication disclosing the use of stimulated Raman scattering, to provide optical amplification. In a later example, U.S. Pat. No. 3,515,897, issued to W. H. Culver, entitled Stimulated Raman Parametric Amplifier, discloses a design for implementing stimulated Raman scattering for amplification.

In two publications, Physics Letters 27A, pages 253-254 (1968) I. L. Fabellinskii et al; and, Physical Review Letters 19, pages 828-830 (1969) D. H. Rank et. al., there are discussions regarding stimulated thermal Rayleigh scattering, but the discussions do not involve the amplification of an input signal.

In two publications, JETP Letters 2, pages 25-27 (1965) D. I. Mash et. al.; and, Physical Review 171, pages 160-171 (1968) M. Denariez et. al., there are discussions regarding the use of Rayleigh wing scattering to amplify an optical signal. However, the investigation by M. Denariez et. al. lacked the optical hardware necessary to resolve the narrow frequency difference between the pump and signal. The examination was therefore only limited to the light generated in the backward direction. The work done by D. I. Mash et. al. discusses the first observation of stimulated Rayleigh wing scattering. But the signal they generate has only a pump laser as its input and there is no discussion of amplification of another beam.

Use of Raman scattering for optical signal amplification has limitations in its operation and implementation. Examination of the equations that govern stimulated Raman scattering break down into two terms. The first term is associated with the wave that is being amplified, also known as the Stokes wave. The second term is associated with a material excitation that is a product of the Raman scattering. That material excitation causes inherent inefficiencies and engineering difficulties that cannot be removed. Consequently, stimulated Raman scattering can be considered as a parametric or coupled generation process in which the optical pump wave generates a Stokes wave (i.e. the amplified input) and a material excitation wave. This material excitation wave is part of the coupled wave physical process, which allows the input beam to be amplified, but does not contribute anything to the desired amplification. The energy that is distributed to the material excitation is lost to the optical output. Furthermore, this material wave eventually couples its energy into thermal excitations within the media, so that it contributes to waste heat in the process. This heat can lead to immediate distortions in the efficiency of the optical amplifier and long-term deterioration of the amplifier medium itself. Considerable engineering must take place in the optical design to handle this problem, causing the system to be bulkier and heavier than it might be otherwise.

The inherent difficulty with Raman scattering is that the material excitation itself is a high energy excitation. In order to use a Raman active medium for amplification, the optical implementation is constrained to excite the material parameter inherent to the medium. These excitations are associated with vibrational resonances in the infrared segment of the electromagnetic spectrum. The associated wavelengths of these excitations will be in the three to ten micron regimes. A typical amplifier beam will be in the mid-visible, at a wavelength of approximately 0.5 micron. Consequently, 10% of the pump beam will be lost to the material excitation, even if the optical system is lossless otherwise. For high power long-term operation, this is a considerable loss.

### SUMMARY

In a broad aspect, the stimulated Rayleigh scattering optical amplifier of the present invention includes a first control optics assembly, a driver element, a second control optics assembly, a Rayleigh active medium and egressing optics. The first control optics assembly receives an incoming laser beam and adjusts that incoming laser beam in accordance with first desired wavelength, polarization and beam propagation parameters. A driver element produces a driver laser beam. A second control optics assembly receives the driver laser beam and adjusts that driver laser beam in accordance with second desired wavelength, polarization and beam propagation parameters. A Rayleigh active medium receives an output from the first control optics assembly and an output from the second control optics assembly. The Rayleigh active medium provides a non-linear optical interaction between the outputs such that the incoming laser beam is amplified producing an amplified Rayleigh active medium output laser beam and a depleted driver laser beam. Egressing optics receives the amplified Rayleigh active medium output laser beam and the depleted driver laser beam. The egressing optics controllably transmits the amplified Rayleigh active medium output laser beam in accordance with third desired wavelength, polarization and beam propagation parameters and prevents transmission of the depleted driver laser beam. The output of the egressing optics includes an amplified egressing optics output laser beam.

The use of Rayleigh scattering allows parametric amplification of a weak signal with considerably less energy loss to the excitation-coupling medium than Raman scattering. This makes the overall system operation more energy efficient. It reduces the amount of engineering and design necessary to remove the large amount of waste heat associated with the Raman process, if such a process were used. As a result, the hardware associated with the use of this amplifier in an optical system, such as an optical communication system, minimizes volume and weight. Furthermore, it provides enhanced energy efficiency.

### BRIEF DESCRIPTION OF THE DRAWINGS

FIG. 1 is a schematic view of a preferred embodiment of the stimulated Rayleigh scattering optical amplifier of the present invention.

FIG. 2 is a schematic view of a communication system implementing a stimulated Rayleigh scattering optical amplifier in accordance with the principles of the present invention.

### DETAILED DESCRIPTION OF THE INVENTION

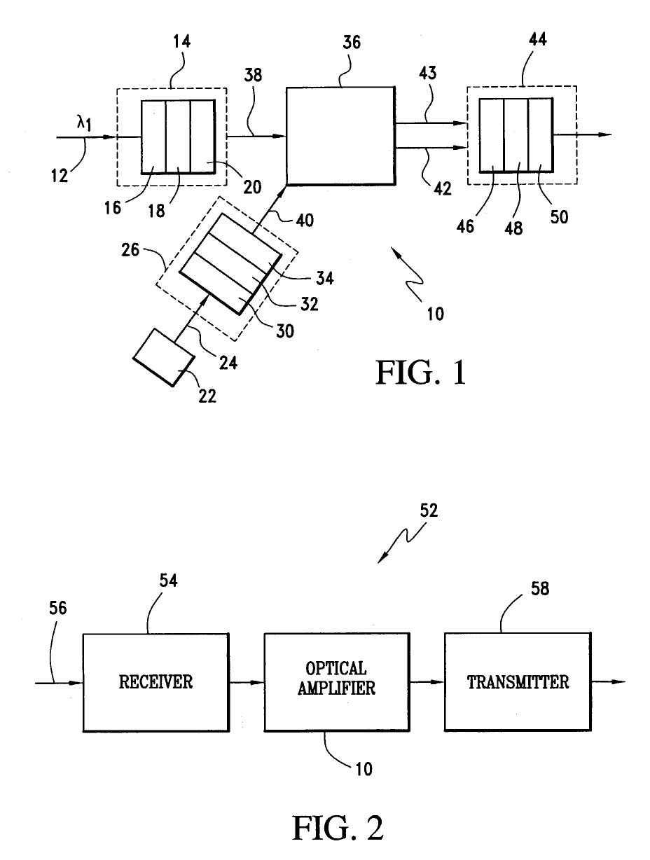

Referring to the drawings and the characters of reference marked thereon, FIG. 1 illustrates a preferred embodiment of the present invention, designated generally as 10. An incoming laser beam 12 is received by a first control optics assembly, designated generally as 14. The laser beam, λ₁, may be generally described as an electromagnetic or light beam with a single narrow wavelength in the optical regime (0.1-10 microns), which is propagating in a uniform well-defined direction, made possible by its coherence properties. The laser beam could represent an image or could be a digitally encoded optical beam for data transmission.

The first control optics assembly 14 adjusts the incoming laser beam in accordance with first desired wavelength, polarization and beam propagation parameters. These parameters can include, for example, precise wavelength filtering to the expected signal wavelength, the optical bandwidth of the incoming signal, or the polarization of the light. The wavelength may be controlled to fit within the transparency range of the ensuing steerer. It may be more precisely filtered to fit a known input signal, either from an image or from a digitally encoded communication beam.

The assembly 14 preferably includes a wavelength control element 16 such as a color filter, an etalon, a Fabry-Perot interferometer, a Fizeau interferometer, a diffraction grating or a notch filter, etc. A polarization control element 18 polarizes the wavefront. This may comprise, for example, a polarization plate, a Brewster's angle polarizer or a thin film polarizer. The precise polarizer to be selected depends on the particular application's engineering requirements such as polarization rejection ratio, size and weight of the polarizer, and the wavelength range over which the steerer must operate, etc. The wavefront is then received by a propagation control element 20 such as a single lens, double lens, refractive elements, reflective elements or other system up to a fully engineered telescope.

A driver element 22, for encoding, produces a driver laser beam 24. The driver element 22 may comprise, for example, a single frequency laser, with sufficiently high intensity to affect a nonlinear optical interaction with the incoming beam described previously. This could be a solid state laser, a high power diode laser or any number of high intensity lasers.

A second control optics assembly 26 adjusts the driver laser beam 24 in accordance with desired wavelength, polarization and beam propagation parameters. The assembly 26 preferably includes wavelength control element 30, such as a color filter, an etalon, a Fabry-Perot interferometer, a Fizeau interferometer, a diffraction grating or a notch filter. A polarization control element 32 and a propagation control element 34 are utilized, as described above.

A Rayleigh active medium 36 receives an output 38 from the first control optics assembly 14 and an output 40 from the second control optics assembly 26. The Rayleigh active medium 36 provides a non-linear optical interaction between the outputs 38, 40 such that an amplified Rayleigh active medium output laser beam 42 and a depleted driver laser beam 43 are provided. Using stimulated Rayleigh scattering as a means of amplification provides a lower cost solution than other stimulated optical scattering techniques that do not have as much energy coupled into the material excitation. In this process, as in all stimulated processes, there is a material excitation present as the physical entity that couples the pump and signal waves. However, in this case, the excitation is an acoustic wave. A typical frequency shift associated with a Rayleigh event is on the order of a few GHz, 10⁶ times smaller than that associated with a Raman excitation. Consequently, the energy loss to the material excitation and subsequently to the medium, are negligible as compared to the Raman case.

The gain coefficient for the stimulated Rayleigh process is given in Chapter 11 of Principles of Nonlinear Optics by Y. R. Shen. Quoted here, the gain coefficient, G_{R}, is given by

$${G}_{R} = \frac{{ω}_{2}^{2} γ {γ}^{R}}{4 π {c}^{2} {ρ}_{0} v {Γ}_{RL}} ,$$

where ω₂ is the pump laser frequency, γ is the electrostrictive coefficient,

$${γ}^{R} = \frac{( δ - 1 ) c γ {Γ}_{RL}}{4 n v {ω}_{2}} ,$$

c is the speed of light, ρ₀ is the density, v is the frequency of the Rayleigh excitation, δ is the ratio of the heat capacities and constant pressure and at constant volume, n is the index of refraction,

$${Γ}_{RL} = \frac{{{λ}_{T} ( {k}_{1} + {k}_{2} )}^{2}}{{ρ}_{0} {C}_{p}} ,$$

λ_{T} is the thermal conductivity, k₁ and k₂ are the wavevectors of the signal and pump laser, respectively, and C_{P} is the heat capacity at constant temperature.

The driver output 40 enters the Rayleigh active medium 36 along with the weak beam 38 whose intensity is to be amplified. Via a coupled wave X⁽³⁾ process, energy is transferred from the pump or driver beam 43 to the weak beam 38. The material excitation present as the physical entity that couples the pump and signal waves is an acoustic wave. A typical frequency shift associated with a Rayleigh event is on the order of a few GHz. The physical process that leads to the growth of the acoustic wave also leads to the growth of the weak beam 38, as the wave processes are coupled.

Examples of Rayleigh active media include carbon disulphide (CS2), toluene, doped optical fiber, acetone, n-hexane, toluene, CCl₄, methanol, benzene, H₂O, and cyclohexane. Such materials allow good efficiency in the nonlinear optical interaction. They preferably operate in a frequency range of about 1-2 GHz.

The Rayleigh active medium may be a stimulated thermal Rayleigh material comprising a multi-component material. An acoustic wave, which can be described as a time dependent density variation in the material in question, is more general than that described in the above paragraphs. In the previous case, the light scattering is assumed to contain low-frequency thermodynamic fluctuations in a single-component medium. The density fluctuation is actually a function of pressure, p, and entropy, S. Then, the material excitation will include pressure, wave and entropy wave components. Rather than using the thermodynamic variables p and S, one can use the independent quantities, ρ and T. Including absorption of the light energy (which is neglected in normal stimulated Rayleigh scattering), heating of the sample can occur. Light scattering under a condition of heating caused by material absorption is called thermal Rayleigh scattering. The gain coefficient for thermal Rayleigh scattering, G_{TR}, is given by

$${G}_{TR} = \frac{{ω}_{2}^{2} γ {γ}^{a}}{4 π {c}^{2} {ρ}_{0} v {Γ}_{RL}} ,$$

where ω₂ is the pump laser frequency, γ is the electrostrictive coefficient,

$${γ}^{a} = \frac{α v {c}^{2} {β}_{T}}{{C}_{P} {ω}_{2}} ,$$

c is the speed of light, ρ₀ is the density, v is the frequency of the Rayleigh excitation, β_{T} is the isothermal compressibility,

$${Γ}_{RL} = \frac{{{λ}_{T} ( {k}_{1} + {k}_{2} )}^{2}}{{ρ}_{0} {C}_{p}} ,$$

λ_{T} is the thermal conductivity, k₁ and k₂ are the wavevectors of the signal and pump laser, respectively, and C_{P} is the heat capacity at constant temperature.

Materials which exhibit thermal Rayleigh scattering are typically multi component systems, composed primarily of a Rayleigh active medium, combined with a small amount of material which is absorptive at the material excitation resonance. For example, CS₂ or CCl₄ doped with I₂ will produce a medium which exhibits thermal Rayleigh scattering. This multi-component material includes a Rayleigh active material that exhibits thermal Rayleigh scattering, combined with a small amount of material that is absorptive at the material excitation resonance. Such a material may be, for example, CS₂ or CCl₄ doped with I₂.

In some materials, local fluctuations of molecular orientation and distribution in a fluid medium will lead to dielectric constant fluctuations and spontaneous light scattering. The local molecular orientation changes will lead to a spectral response that is similar to normal Rayleigh scattering, but will be broader. As with normal Rayleigh and thermal Rayleigh scattering, stimulated Rayleigh-wing scattering is possible. Quoted here, the gain coefficient, G_{RW}, is given by

$${G}_{RW} = \frac{2 π {ω}_{2}^{2}}{cn} Im {χ}_{RW}^{( 3 )} {\vert {E}_{1} \vert}^{2} ,$$

where ω₂ is the pump laser frequency, n is the index of refraction, c is the speed of light, X_{RW}⁽³⁾ is the third order Rayleigh-wing susceptibility, and |E₁| is the absolute magnitude of the pump laser.

Egressing optics 44 receives the output 42 of the Rayleigh active medium 36 and adjusts that laser beam in accordance with desired wavelength, polarization, and beam propagation parameters. The output of the egressing optics has the laser beam propagation direction shifted relative to the incoming laser beam direction. Egressing optics 44 includes an egressing wavelength control element 46, an egressing propagation control element 48 and an egressing polarization control element 50. These components may be discussed above with respect to assemblies 14 and 26.

Referring now to FIG. 2, integration of the stimulated Rayleigh scattering optical amplifier 10 of the present invention is illustrated into an optical communication system, designated generally as 52. The communication system 52 includes an optical receiver 54 that receives a relatively weak signal 56 entering via, for example, a fiber or free space. The receiver 54 may be, for example, a telescope or commercially available fiber terminator for collecting a free space propagated signal or fiber optically propagated signal, respectively. The optics associated with the receiver will be a combination of refractive or reflective elements which couple the weak input into the amplifier stage. The optical amplifier 10 receives the output from the receiver 54 and provides an output to an optical transmitter 58. The optical transmitter 58 may typically be a telescope, if free space, or fiber launcher for fiber optic based propagation. The optics associated with the transmitter is a suitable a combination of refractive or reflective elements which couple the amplified signal from the amplifier stage.

The optical communication system may be used for a number of applications. For example, it may be an optical repeater for a telecommunication system, a long distance internet communication system or short haul distribution system for connecting to individual users.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A stimulated Rayleigh scattering optical amplifier, comprising:
a) a first control optics assembly for receiving an incoming laser beam and adjusting that incoming laser beam in accordance with first desired wavelength, polarization and beam propagation parameters;
b) a driver element for producing a driver laser beam;
c) a second control optics assembly for receiving said driver laser beam and adjusting that driver laser beam in accordance with second desired wavelength, polarization and beam propagation parameters;
d) a Rayleigh active medium for receiving an output from the first control optics assembly and an output from the second control optics assembly, said Rayleigh active medium providing a non-linear optical interaction between said outputs such that the incoming laser beam is amplified producing an amplified Rayleigh active medium output laser beam and a depleted driver laser beam; and,
e) egressing optics for receiving said amplified Rayleigh active medium output laser beam and said depleted driver laser beam, said egressing optics for controllably transmitting said amplified Rayleigh active medium output laser beam in accordance with third desired wavelength, polarization, and beam propagation parameters and preventing transmission of said depleted driver laser beam, the output of said egressing optics comprising an amplified egressing optics output laser beam.

2. The optical amplifier of claim 1, wherein said first control optics assembly, comprises:
a first set of serially positioned control elements for receiving the incoming laser beam, said first set of control elements comprising a first wavelength control element, a first propagation control element and a first polarization control element, said first set of control elements providing an first control optics assembly output to said Rayleigh active medium.

3. The optical amplifier of claim 1, wherein said first control optics assembly, comprises:
a first set of serially positioned control elements for receiving the incoming laser beam, said first set of control elements comprising a first wavelength control element, a first propagation control element and a first polarization control element, said first set of control elements providing an first control optics assembly output to said Rayleigh active medium.

4. The optical amplifier of claim 1, wherein said Rayleigh active medium comprises carbon disulphide (CS2).

5. The optical amplifier of claim 1, wherein said Rayleigh active medium comprises toluene.

6. The optical amplifier of claim 1, wherein said Rayleigh active medium comprises acetone.

7. The optical amplifier of claim 1, wherein said Rayleigh active medium comprises n-hexane.

8. The optical amplifier of claim 1, wherein said Rayleigh active medium comprises CCl.

9. The optical amplifier of claim 1, wherein said Rayleigh active medium comprises methanol.

10. The optical amplifier of claim 1, wherein said Rayleigh active medium comprises cyclohexane.

11. The optical amplifier of claim 1, wherein said Rayleigh active medium comprises a stimulated thermal Rayleigh material.

12. The optical amplifier of claim 1, wherein said Rayleigh active medium comprises a stimulated thermal Rayleigh material comprising Rayleigh active material combined with material that is absorptive at the material excitation resonance.

13. The optical amplifier of claim 1, wherein said Rayleigh active medium comprises a stimulated thermal Rayleigh material comprising Rayleigh active material combined with material that is absorptive at the material excitation resonance, said Rayleigh active material comprising CS2 and said absorptive material comprising I₂.

14. The optical amplifier of claim 1, wherein said Rayleigh active medium comprises a stimulated thermal Rayleigh material comprising Rayleigh active material combined with material that is absorptive at the material excitation resonance, said Rayleigh active material comprising CCl and said absorptive material comprising I₂.

15. The optical amplifier of claim 1, wherein said Rayleigh active medium comprises a Rayleigh-wing active material.

16. The optical amplifier of claim 1, wherein said Rayleigh active medium operates in a frequency range of about 1-2 GHz.

17. An optical communication system, comprising:
a) an optical receiver for receiving an incoming laser beam and providing a receiver output;
b) a stimulated scattering optical amplifier, comprising:
i) a first control optics assembly for receiving said receiver output and adjusting that receiver output in accordance with first desired wavelength, polarization and beam propagation parameters;
ii) a driver element for producing a driver laser beam;
iii) a second control optics assembly for receiving said driver laser beam and adjusting that driver laser beam in accordance with second desired wavelength, polarization and beam propagation parameters;
iv) a Rayleigh active medium for receiving an output from the first control optics assembly and an output from the second control optics assembly, said Rayleigh active medium providing a non-linear optical interaction between said outputs such that the incoming laser beam is amplified producing an amplified Rayleigh active medium output laser beam and a depleted driver laser beam; and
v) egressing optics for receiving said amplified Rayleigh active medium output laser beam and said depleted driver laser beam, said egressing optics for controllably transmitting said amplified Rayleigh active medium output laser beam in accordance with third desired wavelength, polarization, and beam propagation parameters and preventing transmission of said depleted driver laser beam, the output of said egressing optics comprising an amplified egressing optics output laser beam; and,
c) a transmitter for receiving said egressing optics output laser beam and providing a transmitter output.

18. The optical communication system of claim 17, wherein said Rayleigh active medium comprises carbon disulphide (CS2).

19. The optical communication system of claim 17, wherein said Rayleigh active medium comprises toluene.

20. The optical communication system of claim 17, wherein said Rayleigh active medium comprises acetone.

21. The optical communication system of claim 17, wherein said Rayleigh active medium comprises n-hexane.

22. The optical communication system of claim 17, wherein said Rayleigh active medium comprises a Rayleigh-wing active material.

23. The optical communication system of claim 17, wherein said Rayleigh active medium operates in a frequency range of about 1-2 GHz.

24. A method for amplifying a laser beam comprising the steps of:
a) adjusting an incoming laser beam in accordance with first desired wavelength, polarization and beam propagation parameters;
b) producing a driver laser beam;
c) adjusting said driver laser beam in accordance with second desired wavelength, polarization and beam propagation parameters;
d) utilizing a Rayleigh active medium for receiving the adjusted incoming laser beam and said adjusted driver laser beam, said Rayleigh active medium providing a non-linear optical interaction between said adjusted incoming laser beams such that the incoming laser beam is amplified producing an amplified Rayleigh active medium output laser beam and a depleted driver laser beam; and,
f) receiving said amplified Rayleigh active medium output laser beam and said depleted driver laser beam, utilizing egressing optics, said egressing optics for controllably transmitting said amplified Rayleigh active medium output laser beam in accordance with third desired wavelength, polarization, and beam propagation parameters and preventing transmission of said depleted driver laser beam, the output of said egressing optics comprising an amplified egressing optics output laser beam.

25. The method of claim 24, wherein said step of adjusting said incoming optical laser beam comprises:
utilizing a first set of serially positioned control elements for receiving the incoming laser beam, said first set of control elements comprising a first wavelength control element, a first propagation control element and a first polarization control element, said first set of control elements providing an output to said driver element.

26. The method of claim 24, wherein said step of adjusting said incoming optical laser beam, comprises:
utilizing a second wavelength control element for receiving the driver optical wavefront; and,
utilizing a second propagation control element for receiving the output of the second wavelength control element.

27. The method of claim 24, wherein said step of utilizing a Rayleigh active medium comprises utilizing carbon disulphide (CS2).

28. The method of claim 24, wherein said step of utilizing a Rayleigh active medium comprises utilizing toluene.

29. The method of claim 24, wherein said step of utilizing a Rayleigh active medium comprises utilizing acetone.

30. The method of claim 24, wherein said step of utilizing a Rayleigh active medium comprises utilizing n-hexane.

31. The method of claim 24, wherein said step of utilizing a Rayleigh active medium comprises utilizing a stimulated thermal Rayleigh material comprising Rayleigh active material combined with material that is absorptive at the material excitation resonance.

32. The method of claim 24, wherein said step of utilizing a Rayleigh active medium comprises utilizing Rayleigh-wing active material.
